(19) United States
(12) Patent Application Publication
(10) Pub. No.: US 2018/0009035 A1
(43) Pub. Date: Jan. 11, 2018

(54) MANUFACTURING METHOD

(71) Applicant: NOV Downhole Eurasia Limited, Gloucestershire (GB)

(72) Inventors: Mark Francis, Gloucestershire (GB); Richard Jordan, Gloucestershire (GB); Michael Barnes, Gloucestershire (GB)

(73) Assignee: NOV Downhole Eurasia Limited, Gloucestershire (GB)

(21) Appl. No.: 15/538,274

(22) PCT Filed: Dec. 18, 2015
(86) PCT No.: PCT/GB2015/054073

§ 371 Date: Jun. 21, 2017

(30) Foreign Application Priority Data
Dec. 22, 2014 (GB) 1422920.7

(51) Int. Cl. B22F 7/06; E21B 10/00; B22F 5/00; B29C 33/38

(52) U.S. Cl. CPC B22F 7/06; E21B 10/00; B22F 2007/066; B22F 2005/001; B29C 33/3842

(57) ABSTRACT

A manufacturing method includes the steps of providing a mould containing a matrix material, providing an infiltrant material arranged so that, when molten, the infiltrant material will infiltrate into the matrix material, and heating the matrix material and the infiltrant material by induction heating using an induction heater. The induction heater includes a first coil and a second coil, wherein the first and second coils are energised independently of one another to allow increased control over the heating of different parts of the matrix material and infiltrant material within the mould.

This invention relates to a method for use in the manufacture of drill bits.

One method in common usage for the manufacture of drill bits involves producing a mould including a mould cavity, locating and supporting a core or blank within the mould cavity, and filling the void between the blank and the mould with a matrix material powder. A quantity of a suitable alloy is positioned within the mould on top of the matrix material. The mould and its contents are then placed into a furnace. Within the furnace, the alloy is heated and will melt. Once molten, the alloy flows into, or infiltrates, voids within the matrix material such that upon subsequent cooling and solidification of the alloy, the alloy serves to bind together the matrix material, bonding the matrix material to the blank.

Whilst such a technique operates satisfactorily, it does have some disadvantages. For example, little control over the temperatures to which various parts of the assembly are heated is possible. As a result, melting of the alloy and infiltration thereof into the matrix material may commence before some parts of the matrix material have reached a sufficient temperature to sustain the infiltration process. Furthermore, during the infiltration process, air located within the voids within the matrix material has to be displaced to make way for the alloy, and as no well defined flow path for the escape of such air from the mould cavity is provided, complete, uniform infiltration may not occur reliably.

After infiltration in this manner, the manufactured drill bit is allowed to cool. Control over cooling is limited and there is the risk that differential thermal contraction during cooling may cause damage to the drill bit. By way of example, typically a quantity of alloy material will remain on top of the matrix material, and this will normally cool and contract more quickly than the matrix material, and so may damage the adjacent part of the drill bill. Similarly, differential thermal contraction between the matrix material and the blank may result in the matrix material pulling away from the blank, weakening the drill bit.

A number of finishing steps are required after production in this manner. By way of example, where a layer of alloy material remains on top of the matrix material, this will normally need to be removed. Furthermore, the end part of the blank, having been subject to a significant heat cycle, will typically need to be removed and a pin member welded thereto to allow the drill bit to be connected, in use, to other components of a drill string or bottom hole assembly, the heat cycle to which the blank has been exposed resulting in the properties of the blank being such that it is unsuitable for this purpose.

Rather than simply introduce the mould and its contents to a furnace to heat the matrix material and alloy, other heating techniques have been proposed. By way of example, U.S. Pat. No. 8,047,260 describes an arrangement in which a mould and its contents are heated using, amongst other techniques, an induction heating process. Similarly, U.S. Pat. No. 7,845,059, U.S. Pat. No. 7,866,419, U.S. Pat. No. 7,832,456, U.S. Pat. No. 6,220,117 and U.S. Pat. No. 7,832,457 describe arrangements making use of induction heating as an alternative to the location of a mould and its contents within a typical furnace. These are merely examples of a number of documents referencing the use of induction heating for these purposes. Others include U.S. Pat. No. 4,186,628, U.S. Pat. No. 6,073,518, U.S. Pat. No. 6,089,123, U.S. Pat. No. 6,394,202, U.S. Pat. No. 6,725,953, U.S. Pat. No. 7,234,550, U.S. Pat. No. 7,350,599 and U.S. Pat. No. 7,469,757.

It is an object of the invention to provide a manufacturing method in which at least some of the disadvantages of known methods are overcome or are of reduced effect.

According to the present invention there is provided a manufacturing method comprising the steps of:
providing a mould containing a matrix material;
providing an infiltrant material arranged so that, when molten, the infiltrant material will infiltrate into the matrix material; and
heating the matrix material and the infiltrant material by induction heating using an induction heater;
wherein the induction heater is operable to permit increased control over the heating of different parts of the matrix material and infiltrant material within the mould.

The induction heater preferably includes at least a first coil and a second coil that are energised independently of one another to allow increased, independent control over the heating of different parts of the matrix material and infiltrant material within the mould.

Depending upon the locations of the coils, the method of the invention may allow, for example, the matrix material to be heated to a temperature sufficient to maintain infiltration before melting of the infiltrant material, thereby enhancing the effectiveness of the infiltration process. Furthermore, after the infiltration process has been completed, by controlling the operation of the first and second coils, cooling of the moulded product may be better controlled so as to allow the risk of, for example, damage arising from differential thermal contraction upon cooling to be reduced.

The method may further comprise a step of using a cooling means to provide further control over the temperature of parts of the matrix material and infiltrant material within the mould.

By way of example, the cooling means may comprise a directional water cooling system operable to allow cooling of parts of the mould.

Conveniently, the heating and/or cooling of the contents of the mould occurs in an inert or reducing atmosphere so as to avoid the occurrence of, for example, undesired oxidation or other reactions.

The method is conveniently employed in the manufacture of a drill bit, in which case the method preferably further comprises a step of locating a blank within the mould.

A temperature sensor, for example in the form of a thermocouple, may be located within the mould and operable to provide information to a control unit indicative of the temperatures within parts of the matrix material and infiltrant material, the output of the temperature sensor conveniently being used in control of the first and second coils so as to control heating of the matrix material and infiltrant material. In addition, or alternatively, the temperature information may be logged and used for quality control purposes. A plurality of temperature sensors may be present.

The induction heating step induces heat within any inductive material components, for example metallic components, located close to the coils. Where the mould is of graphite form, the mould itself may form one of the inductive material components. Energisation of the coils may thus induce heat in any inductive material components, such as parts of the mould and in the matrix material and infiltrant material where they are of, or contain elements of, metallic form. Where a blank is provided then, where the blank is of a metallic material, heat may be induced therein. If desired, for example to obtain more uniform heating or to assist in targeting of heating of certain parts of the matrix material and infiltrant material, one or more additional metallic components may be incorporated or positioned therein. It will be appreciated that these are simply examples of components that may be of inductive material form.

The method may incorporate an additional step of adjusting the position of the mould relative to the coils. Such an arrangement may allow additional control over heating.

If desired, the infiltrant material may be supplied to a closed end of the mould. Such an arrangement may enhance the passage of air out of the matrix material during the infiltration process and so improve manufacturing quality and reliability. The infiltrant material, prior to infiltration into the matrix material, may be located remotely from the mould. By avoiding the location of the infiltrant material on top of the matrix material, the risk of damage to the product is reduced, and the finishing operations are simplified.

Where a blank is provided, as heating of the infiltrant material and matrix material can be better controlled, heating of an end part of the blank can be restricted to a level sufficiently low that the material of the blank can be used to form a pin. By way of example, the blank may be preformed with threads so that no, or substantially no, subsequent finishing thereof is required, or it may be shaped to approximately the required pin shape prior to conducting the infiltration operation, and subsequently, as part of the finishing operation, threads may be formed thereon. As a result, therefore, the required finishing operations may be simplified.

The invention further relates to a drill bit manufactured according to the method outlined hereinbefore. The drill bit may include a blank shaped to include an integral pin region. The invention also relates to methods in which the infiltrant is located in a reservoir remote from the matrix material and/or in which the end part of the blank is maintained at a temperature sufficiently low to allow its subsequent use as a pin.

The invention will further be described, by way of example, with reference to the accompanying drawings, in which:

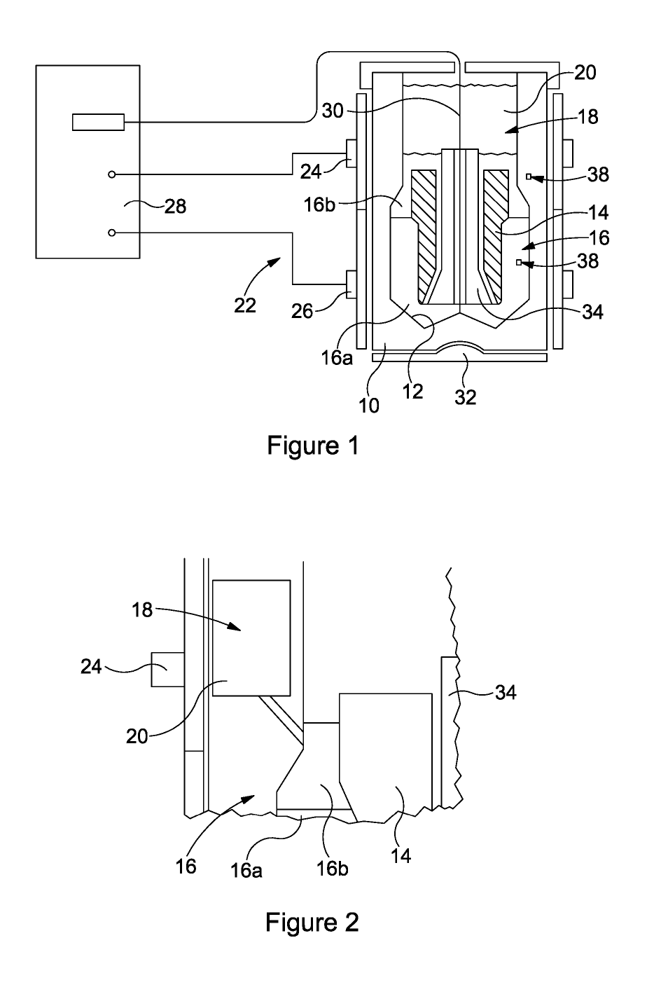

FIG. 1 is a diagrammatic view illustrating a step in a manufacturing method according to an embodiment of the invention;

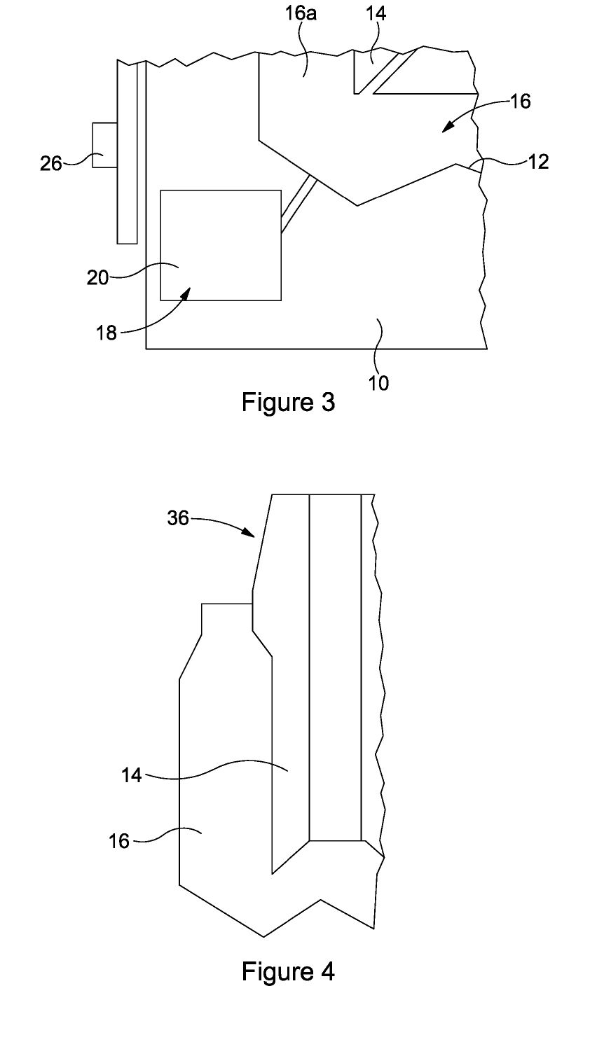

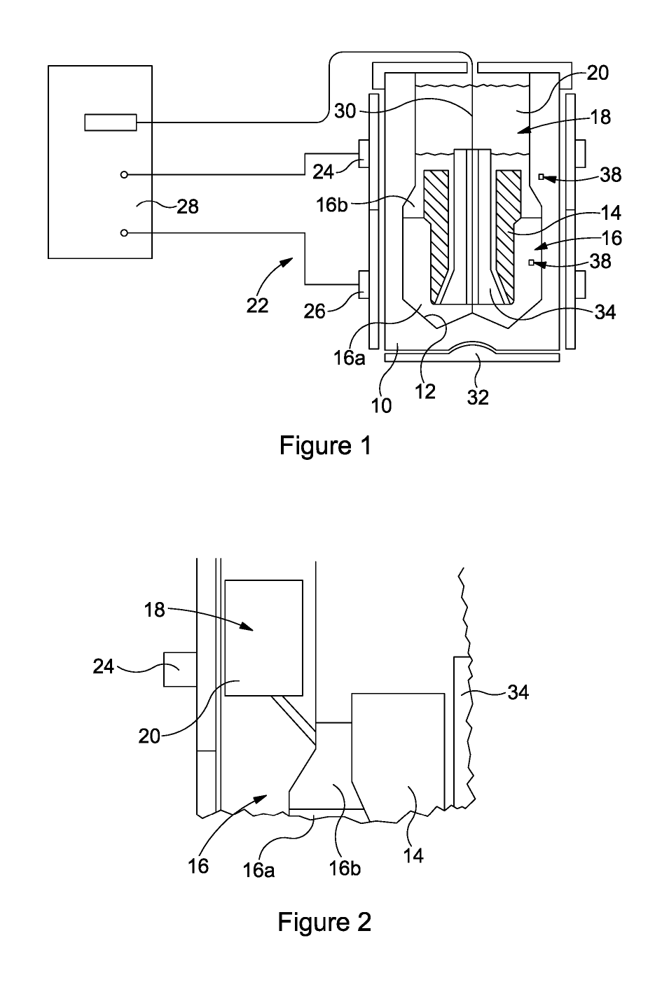

FIGS. 2 and 3 illustrate modifications to the method described with reference to FIG. 1; and

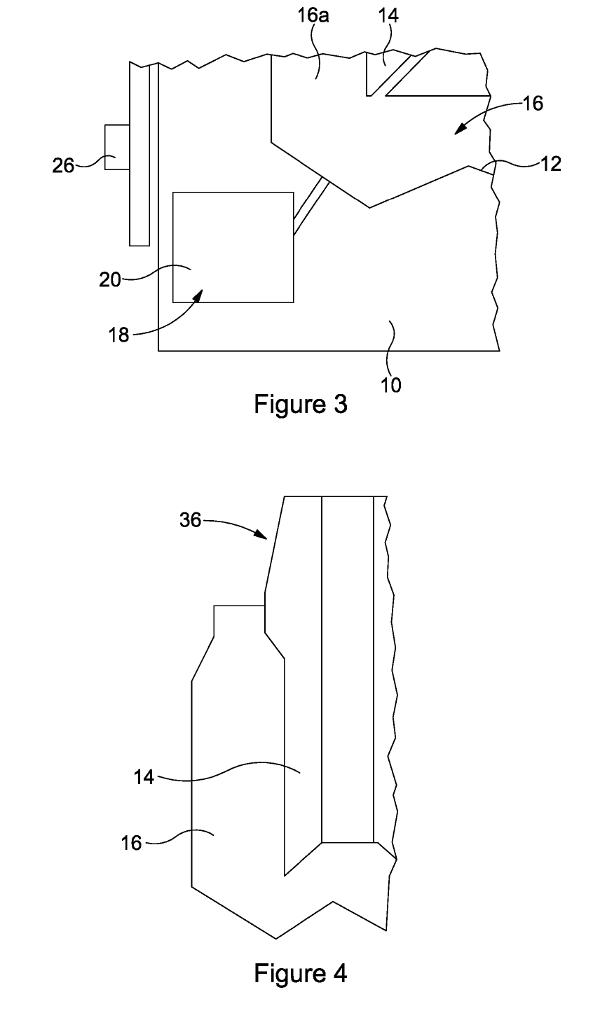

FIG. 4 illustrates, diagrammatically, a drill bit manufactured in accordance with another embodiment of the invention.

Referring firstly to FIG. 1, a method for use in the manufacture of a drill bit in accordance with an embodiment comprises the steps of providing a mould 10 which defines a mould cavity 12. Within the mould cavity 12 is located a blank 14 of steel form which, in the final product will form a core of the drill bit. A void between the blank 14 and the mould 10 is filled with a matrix material 16. Depending upon the required properties of the drill bit, a single type of matrix material 16 may be used. However, in the arrangement illustrated, a relatively hard matrix material powder 16a is located towards the bottom of the mould cavity 12, a relatively soft matrix material powder 16b being positioned thereon. Of course it will be appreciated that this represents merely one example, and that a number of other arrangements are possible without departing from the scope of the invention.

An upper part of the mould cavity 12 defines a funnel or reservoir region 18 within which is located an infiltrant material 20 in the form of nuggets of a suitable alloy material.

The provision of a mould 10 and method of filling the mould 10 to form an assembly of this form is substantially the same as would occur in a typical manufacturing method with the exception that, in the traditional manufacturing method the mould 10, once filled in this manner, would be placed within a conventional furnace for heating to achieve infiltration of the matrix material 16 by the infiltrant material 20.

In accordance with this embodiment of the invention, rather than place the mould 10 and its contents (the blank 14, matrix material 16 and infiltrant material 20) into a conventional furnace to achieve heating thereof, the filled mould 10 is instead heated using an induction heating apparatus 22. The induction heating apparatus 22 is arranged to permit increased control over the heating operation by allowing independent control over the heating of different parts of the filled mould 10 and its contents. In this embodiment, the induction heating apparatus 22 comprises a first induction heating coil 24 and a second induction heating coil 26. Each coil 24, 26 encircles a heating zone within which the mould 10 is positioned, in use. The coils 24, 26 are axially spaced apart from one another, and are controllable independently of one another to allow independent control over the heating and cooling of different parts of the matrix material and infiltrant located within the mould 10. As illustrated, the induction heating apparatus 22 further comprises a control unit 28 to which the coils 24, 26 are connected, the control unit 28 being operable to control the energisation of the coils 24, 26. Whilst a single control unit 28 is illustrated, it will be appreciated that its functions may be distributed amongst, for example, a plurality of control units provided in various locations.

As illustrated, a temperature sensor 30 in the form of a thermocouple arrangement extends into the mould 10 and is arranged to sense the temperature therein at a range of locations. The temperature information from the sensor 30 is supplied to the control unit 28.

In use, with the filled mould 10 located within the heating zone, the control unit 28 controls the energisation of the coils 24, 26 to control heating of the mould 10 and its contents. The output from the temperature sensor 30 is used by the control unit 28 in controlling the operation of the coils 24, 26 to achieve a desired temperature profile within the mould 10 and its contents.

By way of example, initially it may be desired to raise the temperature of the matrix material 16 within the layer 16a. This may be achieved by energisation of the second coil 26. Energisation of the second coil 26, by the application of an alternating current thereto, results in the generation of a magnetic field which is concentrated in the part of the heating zone within the coil 26. The varying magnetic field within the heating zone induces eddy currents within any inductive material objects or components located within the heating zone, and the electrical resistance of the inductive material objects, in combination with the induced eddy currents, causes the generation of heat within the inductive material objects which will dissipate by conduction and radiation to other locations within the mould 10, including to parts thereof of non-inductive material form. Accordingly, the energisation of the second coil 26 will result in heating of the lower part of the blank 14 which is of metallic form. Depending upon the nature of the matrix material, heat may also be generated therein. For example, if the matrix material includes metallic elements, or metallic coated elements, then the energisation of the second coil 26 be induce heat directly within the adjacent matrix material. Likewise, depending upon the material of the mould 10, or any coating applied thereto, heat may be generated therein through the energisation of the coil 26. By way of example, the mould 10 may be of graphite form and so be of an inductive material. Heat transfer between those parts of the mould 10 and the contents thereof in which heat is generated through the energisation of the coil 26 and those parts in which heat is not generated will result in heating of the entirety of the part of the assembly close to the coil 26, heating the matrix material 16.

After the temperature of the matrix material 16 has been raised to a desired level, for example around 1200° C., as sensed by the temperature sensor 30, the first coil 24 may be energised to heat the infiltrant material 20 and other parts of the assembly close thereto. Once the temperature of the infiltrant material 20 has been raised to a level sufficient to cause melting thereof, infiltration of the infiltrant material 20 into air spaces and other voids between the particles of the matrix material 16 will commence. The infiltrant material 20 will flow downward, substantially filling such spaces and voids, air being expelled therefrom towards the upper end of the mould, for example passing along a passage through which the temperature sensor 30 extends. By appropriate control over the energisation of the coils 24, 26, it can be ensured that the temperatures of the various parts of the mould and the contents thereof are held at a desired level to ensure complete infiltration thereof. The level of heat generated depends upon the magnitude of the applied current, and so by appropriate control over the applied currents, the operator has a good level of control over heating of the various parts of the mould and its contents. The level of heat generated can be changed very quickly, simply by adjusting the current applied to each coil.

After infiltration of the matrix material has been completed, the energisation levels of the coils 24, 26 can be controlled so as to allow the mould and its contents to cool in a controlled manner. By way of example, the energisation levels of the coils 24, 26 may be controlled in such a manner as to allow cooling of the materials located towards the bottom, closed end of the mould 10 prior to cooling of the materials closer to the open end of the mould 10, by maintaining the energisation of the first coil 24 at a higher level than that of the second coil 26. By controlling cooling in this fashion, the risk of damage to the moulded product through differential thermal contraction as the product cools, especially due to different levels of contract between the matrix material 16 and any infiltrant material 20 remaining within the reservoir 18, and between the matrix material 16 and the blank 14, can be reduced.

To assist in cooling, a water cooling arrangement 32 may be provided. As illustrated in FIG. 1, the arrangement 32 may be provided adjacent the bottom of the mould 10 and may serve to carry heat away from that end of the mould 10 during the cooling part of the manufacturing method. Preferably, the cooling arrangement 32 is directional, targeting cooling to desired parts of the mould 10 and its contents.

After cooling, the moulded drill bit component is removed from the mould and subjected to a number of finishing processes. These may include, for example, machining away of any infiltrant material 20 remaining within the reservoir 18 after completion of the moulding process. It may also involve machining away part of the matrix material to expose the end of the blank, and the welding of a pin component to the end of the blank, the pin component being used to allow the mounting of the drill bit to other parts of a drilling system, for example for use in boring holes in subsurface formations for the subsequent use in the extraction of hydrocarbons.

Conveniently, the steps of heating and cooling are undertaken with the mould 10 and its contents located within an inert or reducing material atmosphere, thereby avoid or reducing the likelihood of oxidation or the like of the materials within the mould 10.

The manufacture of products such as drill bits in this manner is advantageous in that the method permits faster, more accurate and repeatable heating of a mould and the contents thereof, resulting in a reduction in manufacturing variances. If required, temperature information from the sensor 30 may be stored, for example within the control unit 28, to provide a log indicative of the temperatures to which the various parts of the assembly have been exposed during the manufacturing process.

Whilst FIG. 1 illustrates an arrangement in which the reservoir 18 containing the infiltrant material 20 is located above and directly on top of the surface of the matrix material 16, this need not be the case. FIG. 2 illustrates, diagrammatically, an arrangement in which the reservoir 18 is positioned in a location spaced from the matrix material 16. The manufacturing methodology is the same as with the arrangement of FIG. 1, but by locating the reservoir 18 remotely, the risk of a quantity of infiltrant material 20 remaining on the surface of the matrix material 16 is reduced. Accordingly, the risk of damage occurring during cooling is further reduced. Furthermore, the number of finishing tasks to be undertaken once the product has cooled is reduced. Heating of the infiltrant material 20 may, if desired, be independent of heating of the matrix material 16.

In the arrangement of FIG. 3, rather than have the infiltrant material 20 flowing from the reservoir 18 to a point close to the surface of the matrix material 16, it is instead routed to a location at or close to the bottom, closed end of the mould 10. As a consequence, during the infiltration process, air displaced from the matrix material by the infiltrant material can flow towards the surface of the matrix material 16. Complete, reliable infiltration can thus be achieved.

In the arrangements of FIGS. 2 and 3, as the reservoir 20 is not located immediately above the matrix material, if desired the blank 14 may be designed and shaped so as to incorporate an integral pin region 36 which project above the matrix material 16 as shown in FIG. 4. By appropriate control over the heating of the mould 12 and its contents, it can be ensured that the temperatures to which the pin region 36 are exposed during the manufacturing process are maintained at a sufficiently low level that the properties of the pin region 36 are such that it can be used as the pin component of the completed drill bit. As a consequence, the finishing operation may omit the steps of machining away part of the matrix material to expose the end of the blank and welding a pin component to the end of the blank. Instead, the finishing operation may involve finishing and forming a thread upon the pin region 36. The manufacturing method may thus further be simplified, and the risks of welding defects, concentricity issues and the like are avoided.

Whilst in the arrangements described hereinbefore, a pair of coils 24, 26 is provided, it will be appreciated that more coils may be provided, if desired, providing a greater degree of control over the heating and cooling operations. If desired, the mould and its contents may be positioned in such a manner as to be movable relative to the coils, and/or the coils may be movable relative to one another, thereby permitting further control over the heating and cooling operations.

One or more of the coils may be located internally of the mould, for example within a sand core or mandrel 34 located within the blank 14. Furthermore, if desired, an internal cooling arrangement, for example located within the mandrel, may be provided to permit further control over the cooling operation.

As mentioned above, energisation of the coils results in the generation of heat within metallic components located within the mould and its contents. If desired, for example to aid in achieving a desired heating profile, one or more metallic inserts 38 (see FIG. 1), for example in the form of spheres, rods or of other shapes, may be incorporated into the mould 10, located within the matrix material 16 or otherwise be provided so as to increase the generation of heat within parts of the mould and its contents in the vicinity of the inserts 38.

In the arrangements described hereinbefore, the method is employed in the manufacture of a drill bit comprising a matrix material body mounted upon a support. The invention is not restricted in this regard, and may be used in other applications. By way of example, the method of the invention may be employed in applying a relatively thin matrix material layer to the surface of a metallic material bit body, the matrix material layer serving to enhance the wear resistance of the bit body. In such an arrangement, as the matrix material layer is of relatively thin form, heating thereof may be achieved successfully relying upon heat transfer from the bit body which, being of metallic form, will be heated by the energisation of the coils. The mould may be of a non-inductive material, for example it could take the form of a relatively thin ceramic material shell.

Whilst specific embodiments of the invention are described hereinbefore, it will be appreciated that a wide range of modifications and alterations may be made thereto without departing from the scope of the invention as defined by the appended claims.

1. A manufacturing method comprising the steps of:
providing a mould containing a matrix material;
providing an infiltrant material arranged so that, when molten, the infiltrant material will infiltrate into the matrix material; and
heating the matrix material and the infiltrant material by induction heating using an induction heater;
wherein the induction heater is operable to permit independent control over the heating of different parts of the matrix material and infiltrant material within the mould.

2. The method according to claim 1, wherein the induction heater includes at least a first coil and a second coil that are energised independently of one another to allow increased control over the heating of different parts of the matrix material and infiltrant material within the mould.

3. The method according to claim 2, wherein the energisation of the coils is such as to cause the matrix material to be heated to a temperature sufficient to maintain infiltration before melting of the infiltrant material occurs.

4. The method according to claim 2, further comprising, after the infiltrant material has infiltrated the matrix material, controlling the operation of the first and second coils to control cooling of the product.

5. The method according to claim 1, further comprising a step of using a cooling means to provide further control over the temperature of parts of the matrix material and infiltrant material within the mould.

6. The method according to claim 5, wherein the cooling means comprise a directional water cooling system operable to allow cooling of parts of the mould.

7. The method according to claim 1, further comprising using one or more temperature sensors located within the mould and operable to provide information to a control unit indicative of the temperatures within at least a part of the matrix material and infiltrant material, in controlling the induction heater.

8. The method according to claim 1, further comprising incorporating one or more metallic inserts or elements into at least one of the mould and the matrix material.

9. The method according to claim 1, further comprising an additional step of adjusting the position of the mould relative to the induction heater.

10. The method according to claim 1, wherein the infiltrant material is supplied, when molten, to a closed end of the mould.

11. The method according to claim 1, wherein the infiltrant material, prior to infiltration into the matrix material, is located remotely from the matrix material within the mould cavity.

12. The method according to claim 1, wherein during the infiltration process, the infiltrant material infiltrates upwardly through the matrix material and air displaced from the matrix material by the infiltrant material flows towards the surface of the matrix material.

13. The method according to claim 1 and employed in the manufacture of a drill bit.

14. The method according to claim 13, further comprising a step of locating a blank within the mould.

15. The method according to claim 14, wherein the temperature of an end part of the blank is maintained at a level sufficiently low that the material of the blank can be used to form a pin.

16. The method according to claim 15, wherein the blank is shaped to approximately the required pin shape prior to conducting the infiltration step, and subsequently, as part of the finishing operation, has threads formed thereon.

17. The method according to claim 1, wherein the heating step is undertaken with the mould located within an inert or reducing material atmosphere.

18. The method according to claim 1, wherein the mould is of an inductive material.

19. The method according to claim 18, wherein the mould is of graphite form.

20. The method according to claim 1, wherein the mould is of a non-inductive material.

21. The method according to claim 20, wherein the mould comprises a ceramic material shell.

22. A manufacturing method comprising the steps of:
providing a mould containing a matrix material;
providing an infiltrant material arranged so that, when molten, the infiltrant material will infiltrate into the matrix material, the infiltrant material being located within a reservoir remote from the matrix material.

23. The method according to claim 22, further comprising:
heating the matrix material and the infiltrant material by induction heating using an induction heater including a first coil and a second coil;
wherein the first and second coils are energised independently of one another to allow increased control over the heating of different parts of the matrix material and infiltrant material within the mould.

24. The method according to claim 22 and employed in the manufacture of a drill bit.

25. The method according to claim 22, further comprising a step of locating a blank within the mould.

26. The method according to claim 25, wherein the temperature of an end part of the blank is maintained at a level sufficiently low that the material of the blank can be used to form a pin.

27. The method according to claim 25, wherein the blank is shaped to approximately the required pin shape prior to conducting the infiltration step, and subsequently, as part of the finishing operation, has threads formed thereon.

28. A manufacturing method comprising the steps of:
providing a mould containing a blank and a matrix material;
providing an infiltrant material arranged so that, when molten, the infiltrant material will infiltrate into the matrix material; and
heating the matrix material and the infiltrant material by induction heating;
wherein during the heating step the blank an end part of the blank is maintained at a level sufficiently low that the material of the blank can be used to form a pin.

29. A drill bit manufactured according to the method of claim 1.
